(19) United States
(12) Patent Application Publication
(10) Pub. No.: US 2011/0115778 A1
(43) Pub. Date: May 19, 2011

(54) LIQUID CRYSTAL PANEL AND LIQUID CRYSTAL DISPLAY UTILIZING THE SAME

(75) Inventors: FU-CHENG YANG, Shenzhen (CN); SAI-XIN GUAN, Shenzhen (CN)

(73) Assignees: INNOCOM TECHNOLOGY (SHENZHEN) CO., LTD., Shenzhen City (CN); CHIMEI INNOLUX CORPORATION, Miao-Li County (TW)

(21) Appl. No.: 12/876,249

(22) Filed: Sep. 7, 2010

(30) Foreign Application Priority Data
Nov. 17, 2009 (CN) 200910309855.1

(51) Int. Cl. G09G 5/00; G09G 3/36

(52) U.S. Cl. 345/212; 345/87

(57) ABSTRACT

A liquid crystal display includes a liquid crystal panel having a plurality of pixel units and a plurality of common lines, a common voltage driver for providing common voltage signals to the pixel units; and a pre-charging switch unit electrically coupled between a corresponding common line and a selected data line. The corresponding common line is provided with a first common voltage and a second common voltage respectively in two subsequent frame periods, and the pre-charging switch unit is configured to connect the corresponding common line with the selected data line in a predetermined time period before the common voltage signal applied to the corresponding common line is switched from one of the first and second common voltage to another. A liquid crystal panel is also provided.

### BACKGROUND

1. Technical Field

The disclosure relates to liquid crystal display (LCD) technology, and more particularly, to a liquid crystal panel and an LCD having pre-charging switch units between a data line and a common line thereof.

2. Description of Related Art

LCDs have the advantages of portability, low power consumption, and low radiation, and thus are widely used in various portable information technology products, such as notebooks, personal digital assistants, video cameras, and the like.

FIG. 3 is an abbreviated circuit diagram of a commonly used LCD 10. The LCD 10 includes a scanning driver 11, a data driver 12, a common voltage driver 13 and a liquid crystal panel 14. The liquid crystal panel 14 includes a plurality of rows of parallel scanning lines 141, a plurality of rows of parallel common lines 142 alternating with the scanning lines 141, a plurality of columns of parallel data lines 143 perpendicular to the scanning lines 141 and the common lines 142, and a plurality of pixel units 15 cooperatively defined by the intersecting scanning lines 141 and data lines 143. While the plurality of pixel units 15 cooperatively forms a pixel matrix, to simplify description, only one pixel unit 15 is illustrated in FIG. 3.

In the LCD 10, the scanning lines 141 are electrically coupled to the scanning driver 11 for receiving scanning signals, the common lines 142 are electrically coupled to the common voltage driver 13 for receiving common voltage signals, and the data lines 143 are electrically coupled to the data driver 12 for receiving data signals. Each pixel unit 15 includes a thin film transistor (TFT) 151, a liquid crystal capacitor 152, and a storage capacitor 153. A gate electrode of the TFT 151 is electrically coupled to a corresponding scanning line 141, and a source electrode of the TFT 151 is electrically coupled to a corresponding data line 142. Further, a drain electrode of the TFT 151 is electrically coupled to the liquid crystal capacitor 142. The storage capacitor 153 is electrically coupled between the drain electrode of the TFT 151 and the common line 142, and parallel to the liquid crystal capacitor 152.

Because the data line 143 is perpendicular to the common line 142, each pixel unit 15 may further include a parasitic capacitor 154 between the data line 143 and the common line 342. The parasitic capacitor 154 is located where the data line 143 superposes the common line 142, and is cooperatively formed by the data line 143, the common line 142, and an insulator layer (not shown) therebetween.

Referring to FIG. 4, in operation, the LCD 10 may adopt an inversion driving method, wherein, when the LCD 10 displays an nth frame, the scanning driver 11 provides a scanning signal Vg to the TFT 15 as to switch the TFT 15 on, and thereby the pixel unit 15 is activated. The common voltage driver 13 provides a low level common voltage VCOML to the common line 142, and the data driver 12 provides a positive data voltage Vd1 to charge the liquid crystal capacitor 152 and the storage capacitor 153 by means of the data line 143. Due to the data voltage, the pixel unit 15 is driven to display a picture unit with a corresponding gray level, and during the nth frame period, the aggregation of picture units displayed by all the pixel units 15 of the pixel matrix cooperatively constitutes a frame of the display of the LCD 10.

When the LCD 10 displays an (n+1)th frame, the common voltage driver 13 provides a high level common voltage VCOMH to the common line 142, and the data driver 12 provides a negative data voltage Vd2 to reversely charge the liquid crystal capacitor 152 and the storage capacitor 153, so as to drive the pixel unit 15 to display a corresponding picture unit.

The alternation of positive data voltage Vd1 and negative data voltage Vd2 in the LCD 10 can protect liquid crystal molecules within the liquid crystal capacitors 152 from decay or damage, however, when the data voltage is switched between positive and negative, the common voltage provided to the common line 142 correspondingly alternates between the low level common voltage VCOML and the high level common voltage VCOMH, so as to ensure a potential difference in the liquid crystal capacitor 152. Therefore, a voltage variation in the common line 142 may be excessive, due to a capacitor coupling effect of the parasitic capacitor 154, such variation may further cause the data voltage provided to the pixel unit 15 to be coupled and shift from that output from the data driver 12. This may affect display quality of the LCD 10.

What is needed is to provide an LCD that can overcome the described limitations.

### BRIEF DESCRIPTION OF THE DRAWINGS

The components in the drawings are not necessarily drawn to scale, the emphasis instead placed upon clearly illustrating the principles of at least one embodiment. In the drawings, like reference numerals designate corresponding parts throughout the various views.

FIG. 1 is an abbreviated circuit diagram of an LCD according to an embodiment of the present disclosure.

FIG. 2 illustrates a timing chart for driving the LCD of FIG. 1.

FIG. 3 is an abbreviated circuit diagram of a related-art LCD.

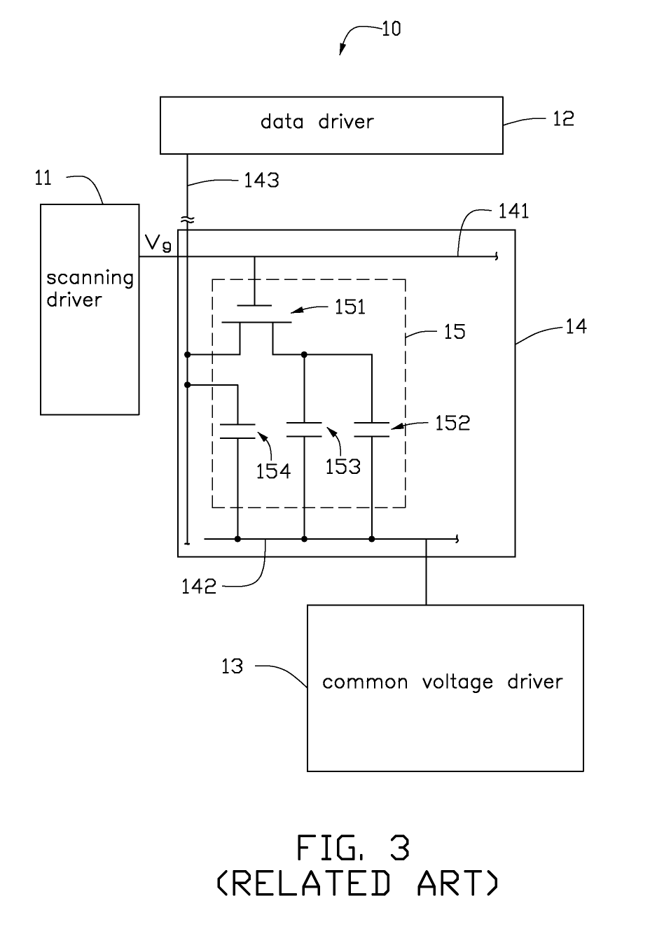

FIG. 4 illustrates a timing chart for driving the LCD of FIG. 3.

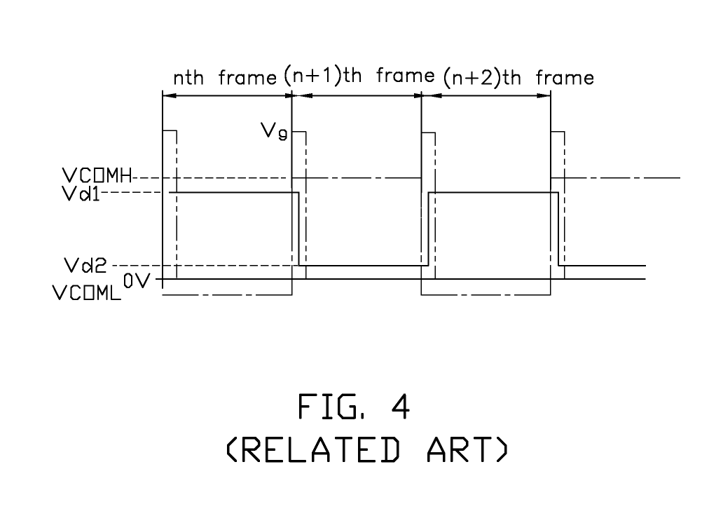

### DETAILED DESCRIPTION

Reference will now be made to the drawings to describe certain exemplary embodiments of the present disclosure in detail.

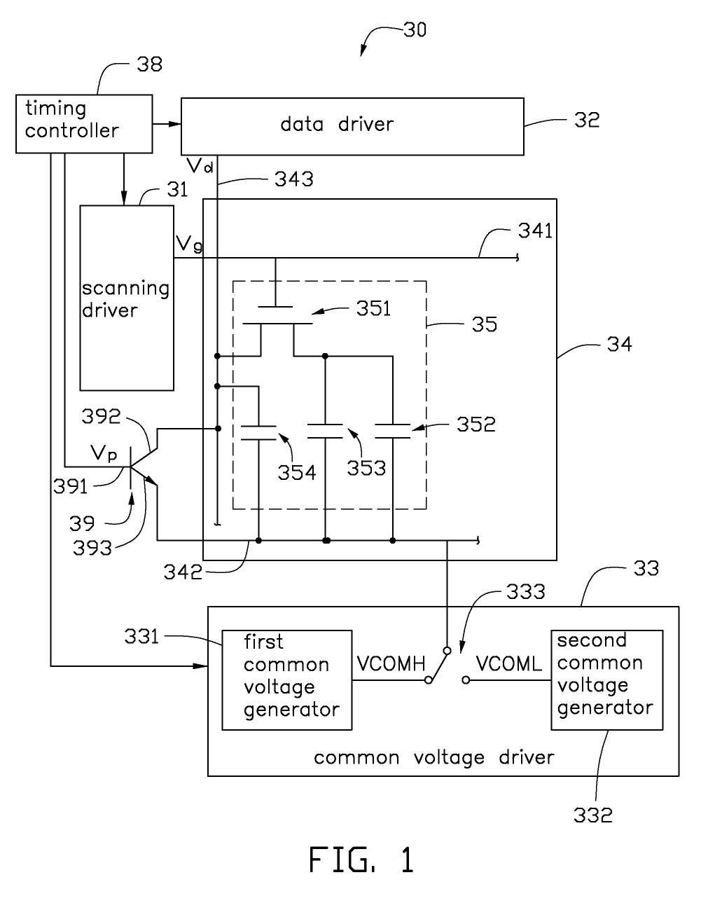

Referring to FIG. 1, an abbreviated circuit diagram of an LCD 30 according to an embodiment of the present disclosure is shown. The LCD 30 includes a scanning driver 31, a data driver 32, a common voltage driver 33, a liquid crystal panel 34, a timing controller 38, and a pre-charging switch unit 39. The liquid crystal panel 34 includes a plurality of rows of parallel scanning lines 341, a plurality of rows of parallel common lines 342 alternating with the scanning lines 341, a plurality of columns of parallel data lines 343 perpendicular to the scanning lines 341 and the common lines 342, and a plurality of pixel units 35 cooperatively defined by the intersecting scanning lines 341 and data lines 343. The plurality of pixel units 35 cooperatively forms a pixel matrix. To simplify the description, only one pixel unit 35 is illustrated in FIG. 1, and the following description is provided commensurate therewith. It is noted, however, that one of ordinary skill in the art would conceive a configuration of the entire pixel matrix based on the following description of the illustrated pixel unit 35.

In the LCD 30, the scanning lines 341 are electrically coupled to the scanning driver 31 for receiving scanning signals, the common lines 342 are electrically coupled to the common voltage driver 33 for receiving common voltage signals, and the data lines 343 are electrically coupled to the data driver 32 for receiving data signals. Each pixel unit 35 includes a thin film transistor (TFT) 351, a liquid crystal capacitor 352, and a storage capacitor 353. A gate electrode of the TFT 351 is electrically coupled to a corresponding scanning line 341, and a source electrode of the TFT 351 is electrically coupled to a corresponding data line 342. Further, a drain electrode of the TFT 351 is electrically coupled to the liquid crystal capacitor 342. The storage capacitor 353 is electrically coupled between the drain electrode of the TFT 351 and the common line 342, and parallel to the liquid crystal capacitor 352.

Because the data line 343 is perpendicular to the common line 342, each pixel unit 35 may further include a parasitic capacitor 354 between the data line 343 and the common line 342. The parasitic capacitor 354 is located where the data line 343 superposes and insulates from the common line 342, and is cooperatively formed by the data line 343, the common line 342, and an insulator layer (not shown) therebetween.

The pre-charging switch unit 39 may correspond to a row of pixel units 35. The pre-charging switch unit 39 includes a control terminal 391 and a pair of connecting terminals 392 and 393. The control terminal 391 is electrically coupled to the timing controller 38, and is configured for receiving a control signal Vp from the timing controller 38. The control signal Vp is used to control a working state of the pre-charging switch unit 39, for example, the control signal Vp may switch the pre-charging switch unit 39 on as to connect the connecting terminals 392 and 393, or switch the pre-charging switch unit 39 off as to disconnect the connecting terminals 392 and 393. The connecting terminals 392 and 393 can be electrically coupled to a selected one of the data line 343 and a common line 342 corresponding to the row of pixel units 35 respectively.

With this configuration, when the pre-charging switch unit 39 is switched on under the control of the control signal Vp, a voltage of the common line 342 can be pre-charged to approximately the same as that of the data line 343. In an embodiment, the pre-charging switch unit 39 can be a transistor, for example, a Negative-Positive-Negative type bipolar junction transistor (NPN BJT), with a base electrode, a collector electrode and an emitter electrode thereof respectively serving as the control terminal 391 and the connecting terminals 392 and 393.

The timing controller 38 is configured to provide a timing signal to the scanning driver 31, the data driver 32, and the common voltage driver 33, so as to control operational timing of these drivers 31, 32 and 33. Moreover, the timing controller 38 may also be configured to output the control signal Vp for controlling the working state of the pre-charging switch unit 39.

The scanning driver 31 is configured to provide a plurality of scanning signals Vg to the pixel units 35, thereby activating the pixel units 35 row by row. The data driver 32 is configured to provide a plurality of data signals Vd to the activated pixel units 35. The common voltage driver 33 is configured to provide a common voltage signal having a predetermined electrical potential level to the common line 342. In particular, the common voltage driver 33 may alternately output a high level common voltage VCOMH and a low level common voltage VCOML according to the timing signal provided by the timing controller 38.

In one embodiment, the common voltage driver 33 may include a first common voltage generator 331 for generating the high level common voltage VCOMH, a second common voltage generator 332 for generating the low level common voltage VCOML, and a selector 333 for selectively outputting one of the high level common voltage VCOMH and the low level common voltage VCOML under the control of the timing signal provided by the timing controller 38. Due to the selective output process, the common voltage driver 33 may respectively output the high level common voltage VCOMH and the low level common voltage VCOML to a common line 342 in two subsequential frame periods.

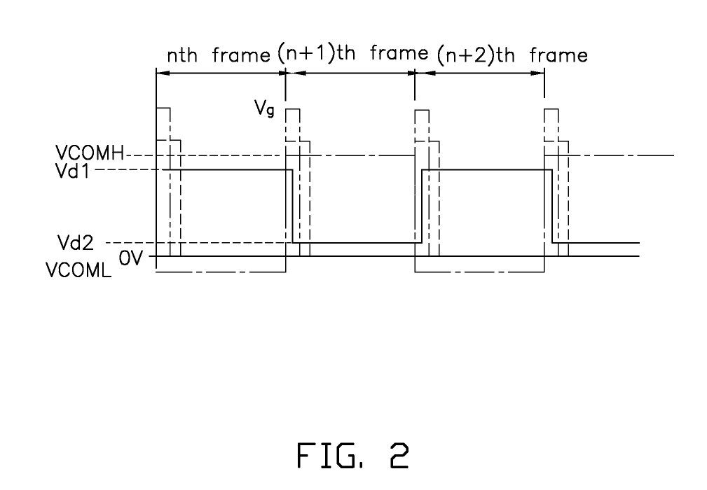

Referring to FIG. 2, in operation, assuming the common voltage driver 33 outputs the low level common voltage VCOML to the common line 342 and the data driver 32 provides a positive data voltage Vd1 to charge the liquid crystal capacitor 352 and the storage capacitor 353 in an nth frame period, before the LCD 30 enters an (n+1)th frame period, the timing controller 38 outputs a control signal Vp to the control terminal 391 of the pre-charging switch unit 39, thus, the pre-charging switch unit 39 is switched on such that the data line 343 is electrically connected with the common line 342. Accordingly, the common line 342 is pre-charged by the positive data voltage Vd1, until an electrical potential of the common line 342 is pulled up from the low level common voltage VCOML to about the positive data voltage Vd1.

When the LCD 30 displays an (n+1)th frame of picture (i.e., enter (n+1)th frame period), the timing controller 38 stops outputting the control signal Vp and accordingly the pre-charging switch unit 39 is switched off, the scanning driver 31 provides a plurality of scanning signals Vg to activate the pixel unit 35 according to a timing signal output from the timing controller 38, and the common voltage driver 13 re-selects the high level common voltage VCOMH as an output signal and then outputs to the common lines 142. Because the common line 342 is pre-charged to about the positive data voltage Vd1 at the end of the nth frame period, the electrical potential of the common line 342 can be pulled up to the high level common voltage VCOMH in a very short time.

In addition, upon activation the scanning signal Vg, the TFTs 351 in the activated pixel units 35 are switched on. Using the pixel unit 35 as illustrated in FIG. 1 as an example, the data voltage provided to the pixel unit 35 by the data driver 32 is switched to a negative data voltage Vd2, and when the TFT 351 of the pixel unit 35 is switched on, the liquid crystal capacitor 352 and the storage capacitor 353 are reversely charged by the negative data voltage Vd2 via the data line 343. After the charging process is finished, the pixel unit 35 is driven to display a picture unit with a gray level corresponding to a potential difference between the data line 343 and the common line 342, and during the (n+1)th frame period, the aggregation of picture units displayed by all the pixel units 35 of the pixel matrix cooperatively constitutes a frame of picture in the LCD 30.

Similarly, at the end of the (n+1)th frame period, the timing controller 38 re-outputs the control signal Vp to switch on the pre-charging switch unit 39 again, and thus the common line 342 is pre-charged to about the negative data voltage Vd2. When the LCD 30 enters an (n+2)th frame period, the control signal Vp is removed and thus the Page of pre-charging switch unit 39 is switched off, and the common voltage driver 13 re-selects the low level common voltage VCOML to output to the common line 142. Due to the pre-charging process, the common line 342 is pre-charged to about the negative data voltage Vd2 prior to the (n+2)th frame period, the electrical potential of the common line 342 can be pulled up to the high level common voltage VCOML quickly in the (n+2)th frame period. Additionally, the data voltage provided to the pixel unit 35 recovers to the positive data voltage Vd1, and the positive data voltage Vd1 charges the liquid crystal capacitor 352 and the storage capacitor 353, so as to drive the pixel unit 35 to display a corresponding picture unit.

Moreover, in alternative embodiments, the pre-charging switch unit 39 can also be integrated in the liquid crystal panel 34, for example, in the form of TFTs. Furthermore, in other alternative embodiments, the LCD 30 can include a plurality of pre-charging switch units 39 each corresponding to a respective common line 342 and coupled between the corresponding common line 342 and a respective data line 343.

In the LCD 30 of the present disclosure, the pre-charging switch unit 39 is employed to enable the voltage of the common line 342 to be adjusted by the data voltage before entering a subsequential frame period. With this configuration, a voltage variation in the common line 342 can be lowered when the LCD 30 switches from a Page of current frame period to a subsequent frame period. As such, the data voltage shift that might otherwise exist decreases, and accordingly, a display quality of the LCD 30 is improved.

It is to be further understood that even though numerous characteristics and advantages of a preferred embodiment have been set out in the foregoing description, together with details of the structures and functions of the embodiments, the disclosure is illustrative only; and that changes may be made in detail, especially in matters of shape, size and arrangement of parts within the principles of disclosure to the full extent indicated by the broad general meaning of the terms in which the appended claims are expressed.

What is claimed is:

1. A liquid crystal display, comprising:
a plurality of pixel units arranged in rows, and a plurality of common lines each corresponding to a respective row of pixel units;
a common voltage driver for providing common voltage signals to the pixel units through the common lines; and
a pre-charging switch unit electrically coupled between a corresponding common line of the common lines and a selected data line;
wherein the pre-charging switch unit is switched on in a predetermined time period before the liquid crystal panel enters a subsequent frame period, so as to connect the corresponding common line with the selected data line and enable the corresponding common line to be pre-charged to a voltage approximating that of the selected data line.

2. The liquid crystal display of claim 1, wherein the pre-charging switch unit comprises a control terminal for receiving a control signal, a first connecting terminal electrically coupled to the corresponding common line, and a second connected terminal electrically coupled to the selected data line, wherein the control signal is configured to switch the pre-charging switch unit on or off.

3. The liquid crystal display of claim 2, wherein the pre-charging switch unit is a transistor, and a base electrode, a collector electrode and an emitter electrode of the transistor are respectively configured as the control terminal, the first connecting terminal, and the second connecting terminal.

4. The liquid crystal display of claim 2, further comprising a timing controller for controlling an operational timing of the liquid crystal panel, wherein the control signal is provided by the timing controller.

5. The liquid crystal display of claim 1, wherein the predetermined time period is at the end of a current frame period of the liquid crystal display, when the liquid crystal display enters the subsequent frame period, the pre-charging switch unit is switched off so as to disconnect the corresponding common line from the selected data line.

6. The liquid crystal display of claim 1, wherein the corresponding common line is provided with a first common voltage and a second common voltage respectively in two subsequent frame periods, the first common voltage exceeds a second common voltage.

7. The liquid crystal display of claim 6, further comprising a data driver for providing data signals to the pixel units, wherein a negative data signal is applied to the selected data line when the first common voltage is applied to the corresponding common line, and a positive data signal is applied to the selected data line when the second common voltage is applied to the corresponding common line.

8. The liquid crystal display of claim 6, wherein the common voltage driver comprises a first common voltage generator for generating the first common voltage, a second common voltage generator for generating the second common voltage, and a selector for selectively outputting one of the first common voltage and the second common voltage to the corresponding common line.

9. The liquid crystal display of claim 1, wherein the pre-charging switch unit is integrated in the liquid crystal panel in the form of thin film transistors.

10. The liquid crystal display of claim 1, further comprising a plurality of pre-charging switch units each corresponding to a respective common line and coupled between the respective common line and a respective data line.

11. A liquid crystal display, comprising:
a liquid crystal panel comprising a plurality of pixel units arranged in N rows, and N common lines each corresponding to a respective row of pixel units;
a common voltage driver for providing common voltage signals to the pixel units through the common lines; and
a pre-charging switch unit electrically coupled between a corresponding common line of the common lines and a selected data line;
wherein the corresponding common line is provided with a first common voltage and a second common voltage respectively in two subsequent frame periods, and the pre-charging switch unit is configured to connect the corresponding common line with the selected data line in a predetermined time period before the common voltage signal applied to the common line is switched from one of the first and second common voltage to another.

12. The liquid crystal display of claim 11, wherein the pre-charging switch unit comprises a control terminal for receiving a control signal, a first connecting terminal electrically coupled to the corresponding common line, and a second connected terminal electrically coupled to the selected data line, wherein the control signal is configured to switch the pre-charging switch unit on or off.

13. The liquid crystal display of claim 12, wherein the pre-charging switch unit is a transistor, and a base electrode, a collector electrode and an emitter electrode of the transistor are respectively configured as the control terminal, the first connecting terminal, and the second connecting terminal.

14. The liquid crystal display of claim 12, further comprising a timing controller for controlling an operational timing of the liquid crystal panel, wherein the control signal is provided by the timing controller.

15. The liquid crystal display of claim 11, wherein the predetermined time period is at the end of a current frame period of the liquid crystal display, when the liquid crystal display enters a subsequent frame period, the pre-charging switch unit is switched off so as to disconnect the corresponding common line from the selected data line.

16. The liquid crystal display of claim 11, wherein the first common voltage exceeds a second common voltage.

17. The liquid crystal display of claim 16, further comprising a data driver for providing data signals to the pixel units, wherein a negative data signal is applied to the selected data line when the first common voltage is applied to the corresponding common line, and a positive data signal is applied to the selected data line when the second common voltage is applied to the corresponding common line.

18. The liquid crystal display of claim 16, wherein the common voltage driver comprises a first common voltage generator for generating the first common voltage, a second common voltage generator for generating the second common voltage, and a selector for selectively output one of the first common voltage and the second common voltage to the common line.

19. The liquid crystal display of claim 11, wherein the pre-charging switch unit is integrated in the liquid crystal panel and in the form of thin film transistors.

20. A liquid crystal panel, comprising:
a plurality of parallel scanning lines;
a plurality of parallel common lines alternating with the scanning lines;
a plurality of parallel data lines perpendicular to the scanning line;
a plurality of pixel units defined by the scanning lines and the data lines; and
a pre-charging switch unit corresponding to a corresponding common line of the common lines, and electrically coupled between the corresponding common line and a selected data line;
wherein the pre-charging switch unit is switched on in a predetermined time period before the liquid crystal panel enters a subsequent frame period, so as to connect the corresponding common line with the selected data line and enable the corresponding common line to be pre-charged by a voltage of the selected data line.
